(19) United States
(12) Patent Application Publication
(10) Pub. No.: US 2017/0309082 A1
(43) Pub. Date: Oct. 26, 2017

(54) PARKING TERMINAL AND METHOD FOR OPERATING A PARKING TERMINAL

(71) Applicant: SKIDATA AG, Grödig/Salzburg (AT)

(72) Inventor: Franz FELLNER, Piding (DE)

(21) Appl. No.: 15/486,668

(22) Filed: Apr. 13, 2017

(30) Foreign Application Priority Data
Apr. 26, 2016 (EP) 16167007.0

(51) Int. Cl. G07B 15/00; G07C 1/30; G06Q 20/04; G06K 9/78; G06K 9/00; G07F 17/42

(52) U.S. Cl. CPC G07B 15/00; G07F 17/42; G07C 1/30; G06K 9/00355; G06K 9/78; G06K 9/00785; G06Q 20/045

(57) ABSTRACT

Proposed is a parking terminal (1), which encompasses a module (2), which integrates at least one component for operation of the parking terminal (1) and/or interaction between the parking terminal (1) and a vehicle passenger of a vehicle standing at the parking terminal (1) which, upon detection of a vehicle standing at the parking terminal (1), is reversibly moved out of the parking terminal (1) by a driving means for a prescribed distance in the direction of the standing vehicle.

This application claims priority from European patent application serial no. 16167007.0 filed Apr. 26, 2016.

### FIELD OF THE INVENTION

The present invention relates to a parking terminal according to the preamble of patent claim 1. In addition, the invention relates to a method for operating a parking terminal, in particular a parking terminal according to the invention.

### BACKGROUND OF THE INVENTION

Known from prior art is to arrange parking terminals in front of the entrances and exits of parking garages, wherein parking terminals located in front of an entrance exhibit a button or key which is used or actuated to dispense a ticket from a ticket dispenser, wherein a parking barrier is actuated for opening purposes, so as to allow a vehicle entry. Parking terminals located in front of exits of parking garages are provided with a device for inserting tickets or card payment means, for example credit cards, wherein once a ticket with valid payment information or a card payment means has been inserted and the corresponding data have been read out, a parking barrier is actuated for opening purposes to allow the vehicle to exit.

The parking terminals are fixedly placed, so that a driver in the car can only actuate the key or button for dispensing a ticket, remove a ticket at an entrance or insert a ticket or a payment means at an exit if the side of the vehicle facing the parking terminal is close enough to the parking terminal in terms of the size or arm length of the driver. However, this cannot always be ensured, so that disadvantageously either the vehicle must be maneuvered or the driver has to get out, which can result in time lost and congestion at the entrance or exit. In addition, a situation might arise in which the driver drives very close to the parking terminal so as to be able to actuate it, which can result in damage to the vehicle and parking terminal.

### SUMMARY OF THE INVENTION

The object of the present invention is to indicate a parking terminal that largely avoids the mentioned disadvantages to prior art. Further to be indicated is a method for operating a parking terminal, in particular a parking terminal according to the invention.

### BRIEF DESCRIPTION OF THE DRAWINGS

The invention will be exemplarily described in greater detail based on the attached Figures, in which:

FIG. 1 is shows a parking terminal, according to the invention, where the module is retracted; and

FIG. 2 is shows a parking terminal, according to the invention, where the module is extended.

### DETAILED DESCRIPTION OF THE PREFERRED EMBODIMENTS

Therefore being proposed is a parking terminal encompassing a module, which integrates at least one component for operation of the parking terminal and/or interaction between the parking terminal and a vehicle passenger of a vehicle standing at the parking terminal, which upon detection of a vehicle standing at the parking terminal can be reversibly moved out of the parking terminal by a driving me axis for a prescribed distance in the direction of the standing vehicle.

The driving means can be designed as an electric motor. Alternatively, the module for extension and retraction can be hydraulically, pneumatically or electromagnetically driven, or the driving means can be designed as a hydraulic, pneumatic or electromagnetic driving means according to prior art.

In a case where the driving means is designed as an electric motor, the extendable module can be moved by means of a rack-and-pinion drive powered by the electric motor for example. Further, a transmission a be placed downstream from the electric motor, e.g., worm transmission, a belt transmission or a spur gear transmission.

According to an embodiment of the invention, the extendable module of a parking terminal located at an entrance integrates a button or key for activating the ticket dispenser and the ticket dispenser, wherein the extendable module of a parking terminal located at an exit integrates a device for inserting a ticket or a card payment means.

Within the framework of another embodiment, the extendable module of a parking terminal located at an exit integrates a button or key for activating the ticket dispenser and the ticket dispenser, wherein the ticket dispenser serves as a device for inserting a ticket or card payment means, and the button or key for activating the ticket dispenser is deactivated in this case. In this way, the extendable modules for the parking terminals located at the entrances and exits can be identical in design.

Further, the extendable module can integrate a touchscreen for operating the parking terminal. According to another embodiment of the invention, the extendable module can integrate a barcode reader for access authorizations.

This ensures that a driver of a vehicle standing at the parking terminal can actuate the parking terminal without having to drive very close to it, even when the side of the vehicle facing the parking terminal is not close enough to the parking terminal in terms of the size and arm length of the driver to operate the parking terminal without extending the module.

The prescribed distance is dimensioned in such a way as to preclude damage to the vehicles. For example, the distance can measure 5 cm.

In parking terminals that exhibit a reader for the touchless readout of access authorizations comprising an antenna, the antenna can be integrated into the extendable module within the framework of another embodiment, so as to thereby resolve any reach-related problems. These types of parking terminals can be located at entrances or exits, for example to offer enhanced comfort to repeat customers, who have access authorizations with touchless readout capability.

Within the framework of another embodiment of the invention, the side of the extendable module facing the vehicles is provided with a layer of elastic material on the edges, thereby preventing damage to a vehicle, for example to a mirror.

In addition, it can be provided according to the invention that, if the continued movement of the module is impeded by an obstacle while extending the module before reaching the end position, the extension is terminated, and the module is retracted to the starting position or by a specific amount. In this way, it is determined whether the module has come to abut against a vehicle. For example, an obstacle can be detected for a case where the driving means is designed as an electric motor by continuously acquiring the power consumption of the electric motor, wherein, once the power consumption exceeds a threshold, an abutment is detected. The distance covered while extending the module can further be acquired independently of the driving means configuration, wherein if the module cannot be extended for the prescribed distance in the direction of the standing vehicle, an abutment is detected.

The parking terminal functions as follows: It is first detected whether a vehicle is standing at the parking terminal, wherein this preferably takes place via at least one induction loop at the entrance or exit, wherein at least one proximity sensor can alternatively or additionally be provided.

Upon detection of a vehicle, the module is extended right away or after a prescribed timespan, so as to enable a comfortable operation of the parking terminal and/or an interaction between the parking terminal and a vehicle passenger of the vehicle standing at the parking terminal. If the module is extended after a prescribed timespan has elapsed from the detection of a vehicle, there is a wait to determine whether an operation takes place within this timespan. Should this not be the case, the module is extended to enable a comfortable operation of the parking terminal and/or an interaction between the parking terminal and a vehicle passenger of the vehicle standing at the parking terminal.

Within the framework of another embodiment of the invention, the parking terminal exhibits a camera, whose images are evaluated in an evaluation unit located in the parking terminal or in a server connected with the parking terminal for data communication, wherein the module is extended when prescribed movement patterns or gestures by the hand of a vehicle passenger of a vehicle standing at the parking terminal are detected. For example, the module is extended upon detection of a wave. The camera can further be used to detect whether the arm of a vehicle passenger of a vehicle standing at the parking terminal is extended in the direction of the module, and his or her hand does not reach the module; in this case, the module is extended. This can also be done when the module is as a rule extended after a prescribed timespan, and a prescribed movement pattern is detected before the prescribed timespan has expired.

In the case of a parking terminal located at an entrance, in which the extendable module integrates the button or key for activating a ticket dispenser and the ticket dispenser, a ticket is coded by means of a coding device situated in the parking terminal and transferred to the ticket dispenser integrated into the module before the module is extended, so that once the button or key for dispensing the ticket has been actuated, it can be dispensed right away, wherein the module is retracted once the ticket has been taken.

In the case of a parking terminal located at an entrance, in which the extendable module integrates the button or key for activating a ticket dispenser and the ticket dispenser, the module is alternatively retracted after the button or key has been actuated, wherein a ticket is coded by means of a coding device situated in the parking terminal and transferred to the ticket dispenser, after which the module is extended to dispense the ticket, wherein the module is retracted once the ticket has been taken.

In the case of a parking terminal located at an exit, in which the extendable module incorporates a device for inserting a ticket or card payment means, the module is extended upon detection of a vehicle, wherein the module is retracted after a ticket or payment means has been inserted, so as to transfer the ticket or payment means to an evaluation unit situated in the parking terminal, wherein once evaluation is complete, the ticket or payment means is transferred by the evaluation, unit to the device for inserting a ticket or card payment means, and the module is extended so as to dispense the ticket or payment means, wherein the module is retracted once the ticket or payment means has been taken.

Provided according to a further development of the invention is that the module be retracted if no operation of the parking terminal and/or no interaction between the parking terminal and a vehicle passenger of the vehicle standing at the parking terminal is detected with the module extended after a prescribed period of time, e.g., when the button or key for activating a ticket dispenser is not actuated or if a ticket is not taken.

In order to transfer the ticket between the coding device situated in the packing terminal and the ticket dispenser and transfer a ticket or payment means from the device for inserting a ticket or card payment means to an evaluation unit situated in the parking terminal and vice versa, rollers are provided to ensure the transfer.

The extendable module can also integrate other components, for example an emergency button and/or a microphone for communicating with personnel of the parking garage operator. According to additional embodiments, at least one other extendable module can further be provided.

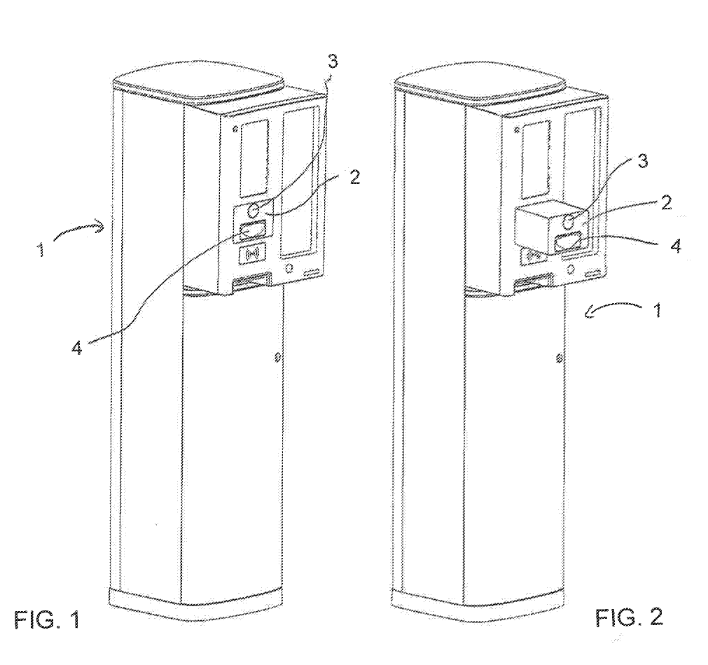

The invention will be exemplarily described in greater detail based on the attached figures. FIG. 1 shows a parking terminal 1 according to the invention, which exhibits an extendable module 2 that integrates a key 3 for activating a ticket dispenser 4 and the ticket dispenser 4, wherein the module 2 is retracted. After a vehicle standing at the parking terminal 1 has been detected, the driving means extends the module 2 by a prescribed distance out of the parking terminal 1 in the direction of the vehicle, so as to enable a comfortable operation of the parking terminal, as illustrated by FIG. 2.

1-15. (canceled)

16. A parking terminal (1), wherein the parking terminal (1) encompasses a module (2) which integrates at least one component for operation of the parking terminal (1) and/or interaction between the parking terminal (1) and a vehicle passenger of a vehicle standing at the parking terminal (1) which, upon detection of a vehicle standing at the parking terminal (1), is reversibly moved out of the parking terminal (1) by a driving means for a prescribed distance in a direction toward the standing vehicle.

17. The parking terminal (1) according to claim 16, wherein the driving means is an electric motor or the driving means is a hydraulic, a pneumatic or an electromagnetic driving means.

18. The parking terminal (1) according to claim 16, wherein the extendable module (2) of a parking terminal (1) located at an entrance integrates a button or a key (3) for activating a ticket dispenser (4), the extendable module of a parking terminal (1) located at an exit integrates a device for inserting a ticket or a card payment means, or the extendable module (2) of a parking terminal (1) located at an exit integrates a button or a key (3) for activating the ticket dispenser (4), and the ticket dispenser (4) serves as a device for inserting a ticket or card payment means, and the button or the key for activating the ticket dispenser is deactivated.

19. The parking terminal (1) according to claim 18, wherein rollers are provided to transfer tickets between a coding device situated in the parking terminal (1) and the ticket dispenser (4) and to transfer a ticket or payment means from the device for inserting a ticket or a card payment means to an evaluation unit situated in the parking terminal (1) and vice versa.

20. The parking terminal (1) according to claim 16, wherein the extendable module (2) integrates a touchscreen for operating the parking terminal and/or a microphone.

21. The parking terminal (1) according to claim 16, wherein a side of the extendable module (2) facing the vehicle standing at the parking terminal (1) is provided with a layer of elastic material along edges.

22. The parking terminal (1) according to claim 16, wherein the driving means is an electric motor, power consumption of the electric motor is continuously acquired, and, once a threshold is exceeded while extending the module (2), an abutment by the module (2) against a vehicle is detected before an end position is reached, and the module (2) is retracted entirely or by a prescribed amount.

23. The parking terminal (1) according to claim 16, wherein the parking terminal (1) has a camera, whose images are evaluated in an evaluation unit located in the parking terminal or in a server, the module (2) is extended when prescribed movement pattern by the hand of a vehicle passenger of a vehicle standing at the parking terminal (1) are detected, or upon detection of extension of the arm of a vehicle passenger of a vehicle standing at the parking terminal (1) in the direction of the module (2), and his or her hand does not reach the module (2).

24. A method of operating a parking terminal (1), in particular a parking terminal (1) according to claim 16, wherein the method detects whether a vehicle is standing at the parking terminal (1), once a vehicle is detected, extending a module (2) integrating at least one component for operation of the parking terminal and/or interaction between the parking terminal and a vehicle passenger of a vehicle standing at the parking terminal (1), out of the parking terminal (1) by a driving means for a prescribed distance in a direction of the vehicle so as to facilitate comfortable operation of the parking terminal (1) and/or an interaction between the parking terminal (1) and a vehicle passenger of the vehicle standing at the parking terminal (1),

25. The method of operating a parking terminal (1) according to claim 24, further comprising:
extending the module (2) immediately after a vehicle is detected,
extending the module (2) after a prescribed timespan,
extending the module (2) when a camera and an evaluation unit situated in the parking terminal (1) or in a server detects prescribed movement pattern by the hand of a vehicle passenger of a vehicle standing at the parking terminal (1), or
extending the module (2) if it is detected that the arm of a vehicle passenger of a vehicle standing at the parking terminal (1) is extended in the direction of the module (2) and his or her hand does not reach the module (2).

26. The method of operating a parking terminal (1) according to claim 25, further comprising detecting a vehicle standing at a parking terminal (1) by at least one induction loop and/or at least one proximity sensor.

27. The method of operating a parking terminal (1) according to claim 25, wherein, in a case of a parking terminal (1) located at the entrance, in which the extendable module integrates the button or key (3) for activating a ticket dispenser (4), a ticket is coded by a coding device situated in the parking terminal (1) and transferred to the ticket dispenser (4) before the module (2) is extended, so that once the button or key (3) for dispensing the ticket is actuated, it can be dispensed right away, and the module (2) is retracted once the ticket has been taken.

28. The method of operating a parking terminal (1) according to claim 25, wherein, in the case of a parking terminal located at the entrance, in which the extendable module integrates the button or key for activating a ticket dispenser, retracting the module after the button or key is actuated, wherein a ticket is coded by a coding device situated in the parking terminal and transferred to the ticket dispenser, after which extending the module to dispense the ticket, and retracting the module once the ticket is taken.

29. The method of operating a parking terminal (1) according to claim 25, wherein, in a case of a parking terminal (1) located at an exit, in which the extendable module (2) integrates a device for inserting a ticket or card payment means, extending the module (2) upon detection of a vehicle, retracting the module (2) after a ticket or payment means is inserted so as to transfer the ticket or payment means to an evaluation unit and, once evaluation is complete, extending the module (2) so as to dispense the ticket or payment means, and retracting the module (2) once the ticket or payment means is taken.

30. The method of operating a parking terminal (1) according to claim 25, further comprising retracting the module (2):
if no operation of the parking terminal (1) and/or no interaction between the parking terminal (1) and a vehicle passenger of the vehicle standing at the parking terminal is detected, or
if no vehicle standing at the parking terminal (1) is detected with the module extended (2) after a prescribed period of time.
